(19) United States
(12) Patent Application Publication
(10) Pub. No.: US 2015/0270544 A1
(43) Pub. Date: Sep. 24, 2015

(54) LITHIUM-ION SECONDARY BATTERY

(71) Applicant: DENSO CORPORATION, Kariya-city (JP)

(72) Inventors: SYUUHEI YOSHIDA, Nagoya-city (JP); YUTA SHIMONISHI, Chita-gun (JP); DAISUKE SHIBATA, Tokai-city (JP); KOJI OHIRA, Chiryu-city (JP)

(21) Appl. No.: 14/663,681

(22) Filed: Mar. 20, 2015

(30) Foreign Application Priority Data
Mar. 24, 2014 (JP) 2014-059839
Dec. 8, 2014 (JP) 2014-247979

(51) Int. Cl. H01M 4/485; H01M 4/525; H01M 10/0525; H01M 4/58

(52) U.S. Cl. CPC H01M 4/485; H01M 4/5825; H01M 4/525; H01M 10/0525; H01M 2220/20; H01M 2220/30

(57) ABSTRACT

A lithium-ion secondary battery includes: a first cathode active material having a polyanion structure which stores and releases a lithium ion; and a second cathode active material having a lithium diffusion coefficient different from a lithium diffusion coefficient of the first cathode active material. The second cathode active material has a layered rock salt-type structure. A discharge curve of the first cathode material and a discharge curve of the second cathode material intersect with each other at at least two points.

### CROSS REFERENCE TO RELATED APPLICATIONS

This application is based on Japanese Patent Applications No. 2014-59839 filed on Mar. 24, 2014, and No. 2014-247979 filed on Dec. 8, 2014, the disclosures of which are incorporated herein by reference.

### TECHNICAL FIELD

The present disclosure relates to a lithium-ion secondary battery.

### BACKGROUND

With the popularization of electronic devices such as notebook computers, mobile phones and digital cameras, the demand for secondary batteries to drive such electronic devices is expanding. Recently, in such electronic devices, power consumption has increased with the progress in high functionality, and downsizing has been expected. Therefore, improvements in performance of secondary batteries are demanded. Since, among secondary batteries, non-aqueous electrolyte secondary batteries (in particular, lithium-ion secondary batteries) can be made to have high capacity, they have been progressively used in various electronic devices.

With regard to non-aqueous electrolyte secondary batteries, besides use of them for such small electronic devices, use of them for purposes, such as for vehicles (EV, HV, and PHV) or household power supplies (HEMS), which require a large amount of power, has been studied. For such purposes, not only improvements in performance of non-aqueous electrolyte secondary batteries but also formation of battery packs which combine non-aqueous electrolyte secondary batteries is proceeding.

In general, non-aqueous electrolyte secondary batteries have a structure in which a cathode, where a cathode active material layer having a cathode active material is formed in a surface of a cathode collector, and an anode, where an anode active material layer having an anode active material is formed in a surface of an anode collector are installed in a battery case, while being connected to one another through a non-aqueous electrolyte (non-aqueous electrolytic solution).

Characteristics (capacity or internal resistance) of lithium-ion secondary batteries, which are a typical example of non-aqueous electrolyte secondary batteries, depend largely on a type of a cathode active material, which electrochemically removes and inserts lithium ions. For a cathode active material for lithium-ion secondary batteries, inorganic powder of lithium oxides, such as LiCoO₂ (hereinafter, referred to as LCO) or LiMn₂O₄ (hereinafter, referred to as LMO) has been used.

It has been known that, with regard to a cathode active material having a polyanion structure including an XO₄ tetrahedron (X=P, As, Si, Mo or the like) in a crystal structure, the structure is stable. Therefore, a compound of an olivine structure (e.g., LiFePO₄), which is one of polyanion structures, has been progressively used as a cathode active material.

However, with regard to olivine-based materials such as LiFePO₄, their electric conductivities (easiness of electric flow on the surface of materials) and their Li diffusion coefficients (easiness of Li ion movement within materials) are a few orders of magnitude smaller than those of LCO and LMO, and thus, they have a problem in which their material resistances are large.

For such a problem, when LiFePO₄ (hereinafter referred to as LFP), which is an olivine-structure material, is used as a cathode active material, nanosizing of the particles and carbon coating are carried out to thereby suppress deteriorations in characteristics of lithium-ion secondary batteries.

Because LFP have a limitation in its electric potential, LFP had been unsuitable for purposes, such as for PHV, where a large amount of electric power is required. That is, there is a limitation in use of LFP for lithium-ion secondary batteries.

For such a problem, studies have been conducted to increase the electric potential in a state where an olivine structure of a cathode active material is maintained. An electric potential of a cathode active material is theoretically determined by a transition metal used therein. As a cathode active material whose electric potential is enhanced, LiFeMnPO₄ (hereinafter referred to as LFMP), which is obtained by replacing a part of Fe of LiFePO₄ (LFP) with Mn, has been studied. In addition, LFMP is a generic name for LiFeMnPO₄-based compounds, and refers to compounds with any atom ratios. The same applies to other generic names.

However, lithium-ion secondary batteries using LFMP have a problem in which decomposition of an electrolytic solution (non-aqueous electrolyte) occurs in an anode, and gas is generated.

Technologies using a cathode active material including LFP and LFMP are described, for example, in Patent Literatures 1-5.

JP-2011-86405-A (corresponding to US 2013/0059199), JP-2010-251060-A and JP-2007-335245-A each disclose technologies in which different types of active materials are mixed, noticing that olivine-based active materials have large Li-diffusion resistance. Specifically, formation of a cathode active material in which a layered active material is mixed with Fe-rich LFMP (JP-2011-86405-A), formation of a cathode active material in which a layered active material is mixed with LFP (JP-2010-251060-A), and formation of a cathode active material in which a mechanical milling treatment of a layered active material is carried out against LFP (JP-2007-335245-A) have been proposed.

Moreover, JP-2014-192154-A proposes provision of a cathode active material in which LiNi_{0.5}Mn_{1.5}O₄ (hereinafter referred to as LNMO) is mixed with Mn-rich LFMP.

Furthermore, JP-2009-99495-A (corresponding to WO 2009/050585) discloses that an active material having high Li-ion diffusibility (a layered cathode active material, e.g. LiNiO₂ (hereinafter, referred to as LNO)) and an active material having low Li-ion diffusibility are placed at sides of a cathode collector and a separator, respectively.

The technologies described in JP-2011-86405-A, JP-2010-251060-A and JP-2007-335245-A aim to alleviate a steep rise in the electric potential of olivine-type cathode active material (a steep electric potential drop of the cathode electric potential) in the terminal stage of electric charging by addition of layered active materials, thereby improving low-temperature characteristics (Li precipitation). Furthermore, a main component of LFMP described in JP-A-2011-86405 is supposed to be Fe. When such Fe-rich LFMP was used, any effects to suppress gas generation at the anode was not recognized.

The technologies described in JP-2011-86405-A, JP-2010-251060-A and JP-2007-335245-A had a problem in which the battery capacity of LNMO which is mixed into LFMP is smaller than the battery capacity of LFMP, and, consequently, the battery capacity of the resulting lithium-ion secondary battery is reduced.

Furthermore, in the technology described in JP-2009-99495-A, highly Li-ion-diffusible LNO (diffusion coefficient: 1×10⁻⁸ cm²/s to 1×10⁻⁶ cm²/s) is disposed at a cathode collector, while low Li-ion-diffusible LMO (diffusion coefficient: 1×10¹⁰ cm²/s to 1×10⁻⁷ cm²/s) is disposed at a separator. The difference between both the diffusion coefficients indicate a four-digit number at a maximum. The diffusion coefficient of LFP is 1×10⁻¹⁴ cm²/s, and a diffusion coefficient of LFMP in the boundary zone is estimated as a few orders of magnitude smaller. That is, it was difficult to apply the technology described in JP-2014-192154-A to LFP or LFMP.

### SUMMARY

It is an object of the present disclosure to provide a lithium-ion secondary battery, in which gas generation at an anode is suppressed.

In order to solve the above-described problem, the present inventors conducted studies on a reaction of LFMP. Consequently, the present inventors found that LFMP of a polyanion structure has a region where the reaction resistance rapidly increases, and that the rapid change in the reaction resistance is a cause of gas generation at an anode. This resulted in completion of the disclosure.

According to an aspect of the present disclosure, a lithium-ion secondary battery includes: a first cathode active material having a polyanion structure which stores and releases a lithium ion; and a second cathode active material having a lithium diffusion coefficient different from a lithium diffusion coefficient of the first cathode active material. The second cathode active material has a layered rock salt-type structure. A discharge curve of the first cathode material and a discharge curve of the second cathode material intersect with each other at at least two points.

The lithium-ion secondary battery has two types of cathode active materials whose discharge curves intersect with each other at at least two points, and electric potential changes of the discharge curve of the whole cathode in the region between the points where the discharge curves intersect with each other are moderate. Because of this, the gap between the discharge curves of the cathode and the anode is suppressed, and gas generation at the anode due to the gap can be suppressed.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic cross-section view showing a structure of a coin-type lithium-ion secondary battery according to a first embodiment;

FIG. 2 is a graph showing discharge curves of LFMP and NMC;

FIG. 3 is a graph showing discharge curves of LFMP, NMC and a cathode;

FIG. 4 is a graph schematically showing a discharge curve of LFMP;

FIG. 5 is a graph showing resistance changes of LFMP;

FIG. 6 is a graph showing discharge curves of LFP and NMC;

FIG. 7 is a graph showing discharge curves of LFP, NMC and a cathode;

FIG. 8 is a perspective view showing a structure of a laminate-type lithium-ion secondary battery according to a second embodiment;

FIG. 9 is a cross-section view showing the structure of the laminate-type lithium-ion secondary battery according to the second embodiment;

FIGS. 10A and 10B are graphs showing potential changes (ΔV/Δt) of Test Examples 11 and 12;

FIG. 11A is an SEM photograph showing a section of Test Example 22, and FIG. 11B is a diagram showing an outline view of FIG. 11A;

FIG. 12 is a graph showing a discharge curve of a cathode of Test Example 31; and

FIG. 13 is a graph showing relations between discharge currents and voltages with respect to Test Examples 55 and 56.

### DETAILED DESCRIPTION

A lithium-ion secondary battery (or a lithium-ion secondary battery) of the disclosure will specifically be described with reference to embodiments.

### First Embodiment

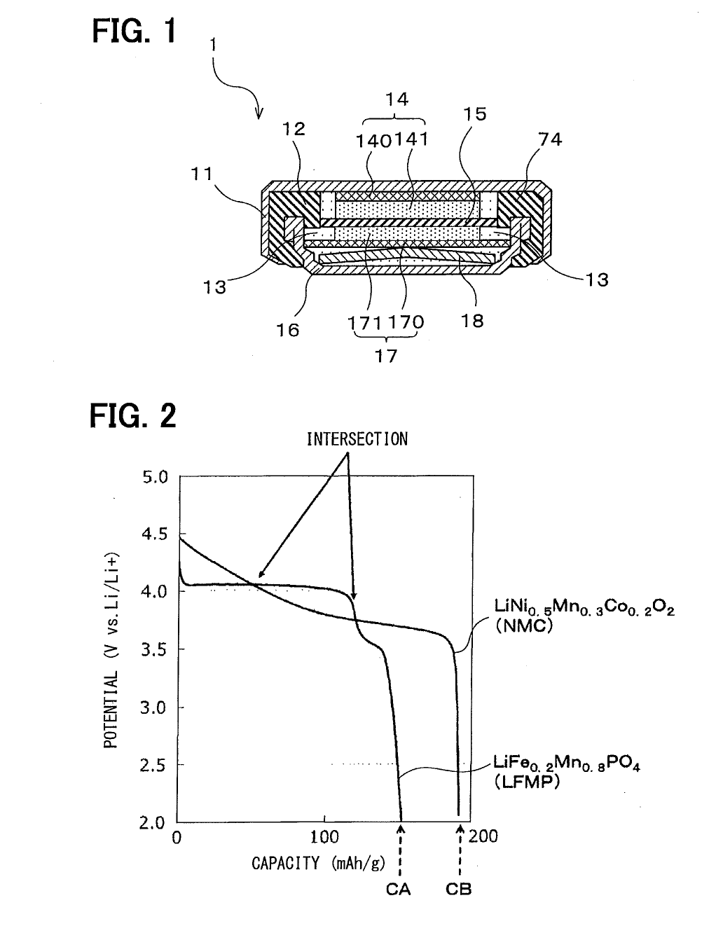

The present embodiment refers to a coin-type lithium-ion secondary battery 1 whose structure is shown in a schematic cross-section view of FIG. 1.

The lithium-ion secondary battery 1 of the present embodiment has a cathode case 11, a seal material 12 (gasket), a non-aqueous electrolyte 13, a cathode 14, a cathode collector 140, a cathode mixture layer 141, a separator 15, an anode case 16, an anode 17, an anode collector 170, an anode mixture layer 171, a holding member 18, and the like.

The cathode 14 of the lithium-ion secondary battery 1 according to the present embodiment has the cathode mixture layer 141 including, as a cathode active material, a first cathode active material 142 having a polyanion structure which can store/release a lithium ion, and a second cathode active material 143 having a lithium diffusion coefficient different from a lithium diffusion coefficient of the first cathode active material 142. The cathode mixture layer 141 includes materials such as binders and conductive materials, as needed, besides the cathode active materials.

In addition, the lithium diffusion coefficient can be measured by methods such as the GITT method (Galvanostatic Intermittent Titration Technique), the PITT method (Potentionstatic Intermittent Titration Technique), and the EIS method (Electrochemical Impedance Spectroscopy).

Furthermore, with regard to the cathode active material, the second cathode active material 143 has a layered rock salt-type structure, and a discharge curve of the first cathode material 142 and a discharge curve of the second cathode material 143 intersect with each other at at least two points.

In the present embodiment, the first cathode active material 142 has a polyanion structure which can store/release a lithium ion. With regard to cathode active materials of a polyanion structure, it has been known that the structure is stable, and thus, high battery performance can be obtained.

The second cathode active material 143 has a lithium diffusion coefficient different from that of the first cathode active material 142, and has a layered rock salt-type structure. Because the second cathode active material 143 has such a different lithium diffusion coefficient, the second cathode active material 143 also can store/release a lithium ion in the same manner as the first cathode active material 142. In other words, the second cathode active material 143 functions as a cathode active material.

The second cathode active material 143 has a crystal structure different from that of the first cathode active material 142, and thus, has a different lithium diffusion coefficient. Furthermore, the layered rock salt-type structure of the second cathode active material 143 makes it easier for lithium to diffuse therein than the polyanion structure of the first cathode active material 142 does, and by inclusion of the two types of cathode active materials, lithium diffusion into the cathode active materials more quickly proceeds, compared with a case where only the first cathode active material 142 is included.

A discharge curve of the first cathode active material 142 and a discharge curve of the second cathode active material 143 intersect with each other at at least two points. As shown as examples in FIGS. 2 to 4, a discharge curve is a diagram showing a relation between a discharge capacity and a battery capacity. In addition, the discharge curve can be obtained by carrying out electric discharge using a cell (battery) which is formed of a cathode using only the cathode active material and an anode (counter electrode) made of metal lithium, followed by measurement of a relation between a discharge capacity and a cathode potential (potential of the cathode active material). FIG. 2 shows discharge curves of LFMP (LiFe_{0.2}Mn_{0.8}PO₄) and NMC (LiNi_{0.5}Mn_{0.3}Co_{0.2}O₂).

Because the discharge curves of two cathode active materials 142 and 143 intersect with each other at at least two points, the two cathode active materials 142 and 143 each have different discharge curves (discharge characteristics). In this case, discharge characteristics of the whole cathode 14 correspond to a discharge curve obtained by combining the two different discharge curves.

In regions other than the intersection points (two points) where the discharge curves intersect with each other, the discharge curve of one cathode active material (hereinafter, referred to as “one discharge curve”, and the same applies to the other cathode active material) is located above the other discharge curve (the potential of the one cathode active material is higher than the potential of the other one). In this case, a potential of the whole cathode is higher than a potential of only the one cathode active material, due to the other cathode active material.

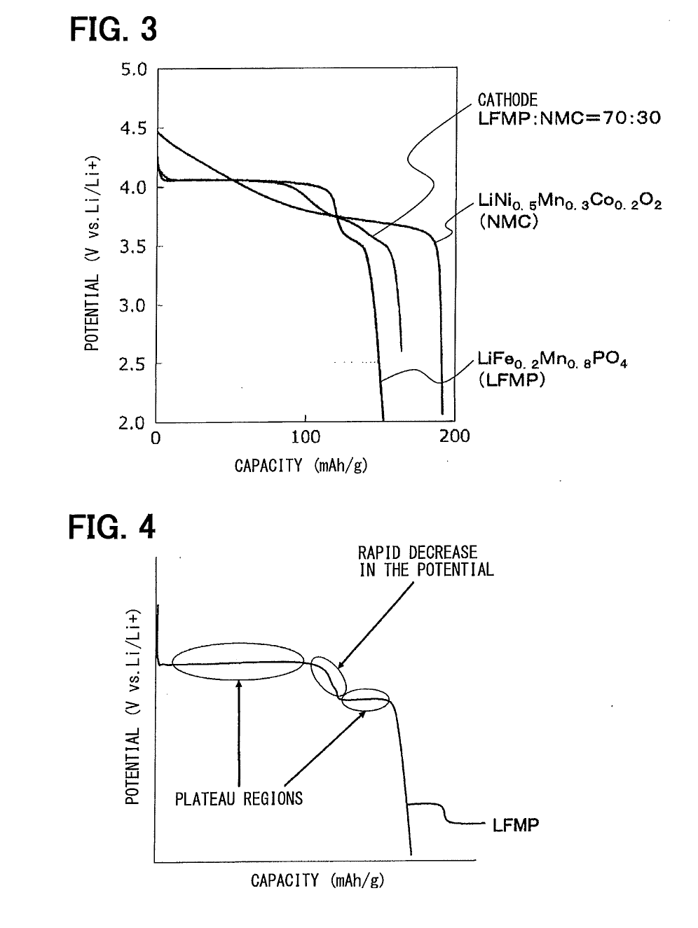

On that basis, in order for respective discharge curves of the two cathode active materials 142 and 143 to intersect with each other at at least two points, as shown in FIG. 3, it is required that one discharge curve is a curve showing rapid changes (potential drop) in the process of electric discharge. In FIG. 3, the discharge curve referred to as “cathode” is a discharge curve of a cathode obtained by mixing LFMP and NMC at a mass ratio where LFMP:NMC=80:20.

As shown in FIG. 3, when the two discharge curves intersect with each other at two points, in regions near the points where the two discharge curves intersect with each other, potential changes of the whole cathode are moderate. In other words, rapid changes (rapid drop of the electric potential) of the potential of the first cathode active material 142 in the course of discharge are suppressed.

A rapid (steep) drop of the potential of the cathode 14 that occurs in the course of electric discharge is generally caused by an increase of the Li diffusion resistance of the cathode active material. When such an increase of the Li diffusion resistance is caused in the course of electric discharge, a gap between potentials (changes of the potentials accompanying the electric discharge) of the cathode 14 and the anode 17 is caused. When the electric discharge proceeds in a state where the potentials of the cathode and the anode deviate from each other, the potential of the anode 17 rapidly increases as a consequence. Then, decomposition of the non-aqueous electrolyte 13 (non-aqueous electrolytic solution) occurs on a surface of the anode 17, and a gas is generated.

A rapid drop of the potential of the cathode 14 that occurs in the course of electric discharge is observed in a cathode active material in which a part of Fe in LFP is replaced with a metal element (e.g. LFMP). A discharge curve of LFMP is schematically shown in FIG. 4. As shown in FIG. 4, a rapid drop of the potential is found in a region between two plateau regions. LFMP exhibits a two-phase coexistent reaction, and two reactions, namely a bivalent/trivalent reaction of Fe and a bivalent/trivalent reaction of Mn, occur.

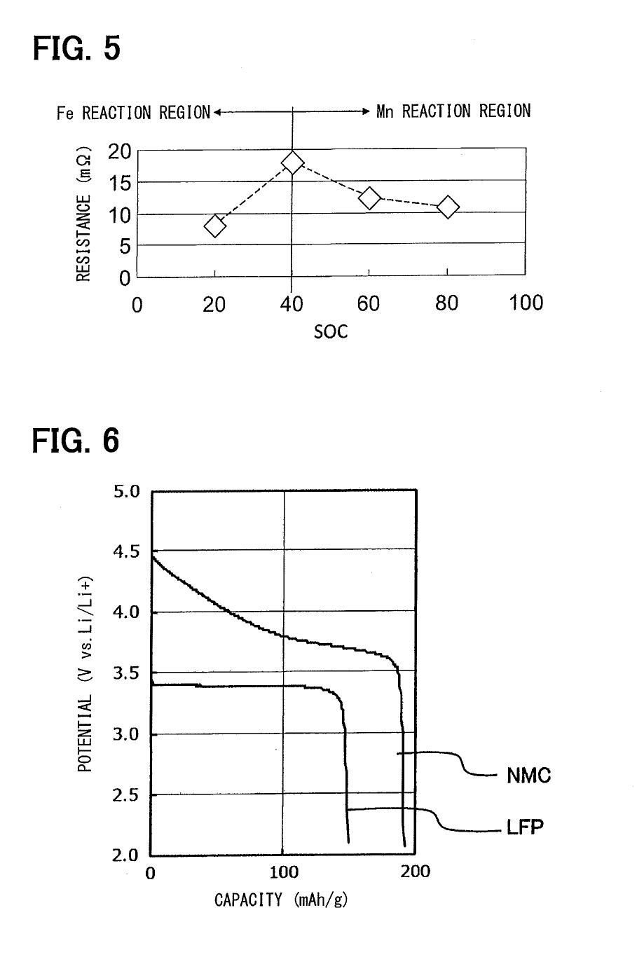

A boundary region between the two reaction, i.e. the bivalent/trivalent reaction of Fe and the bivalent/trivalent reaction of Mn, corresponds to a rapid potential reduction in the course of electric discharge. That is, when the two reactions of Fe and Mn switch to one another, the Li diffusion resistance increases. When this is shown by a figure, as shown in FIG. 5, the resistance reaches its maximum in the boundary region between the two reactions, i.e. the reaction of Fe (a reaction region of Fe) and the reaction of Mn (a reaction region of Mn). In addition, the boundary between the two reactions corresponds to a content ratio of Fe and Mn. Additionally, FIG. 5 is a diagram which schematically shows changes of the output resistance of LiFe_{0.4}Mn_{0.6}O₄.

Furthermore, a case where discharge curves of the two cathode active materials do not intersect with each other is shown in FIG. 6. FIG. 6 refers to discharge curves of LFP and NMC. As shown in FIG. 6, potentials of the two cathode active materials LFP and NMC in plateau regions are totally different from each other, and discharge curves do not intersect with each other.

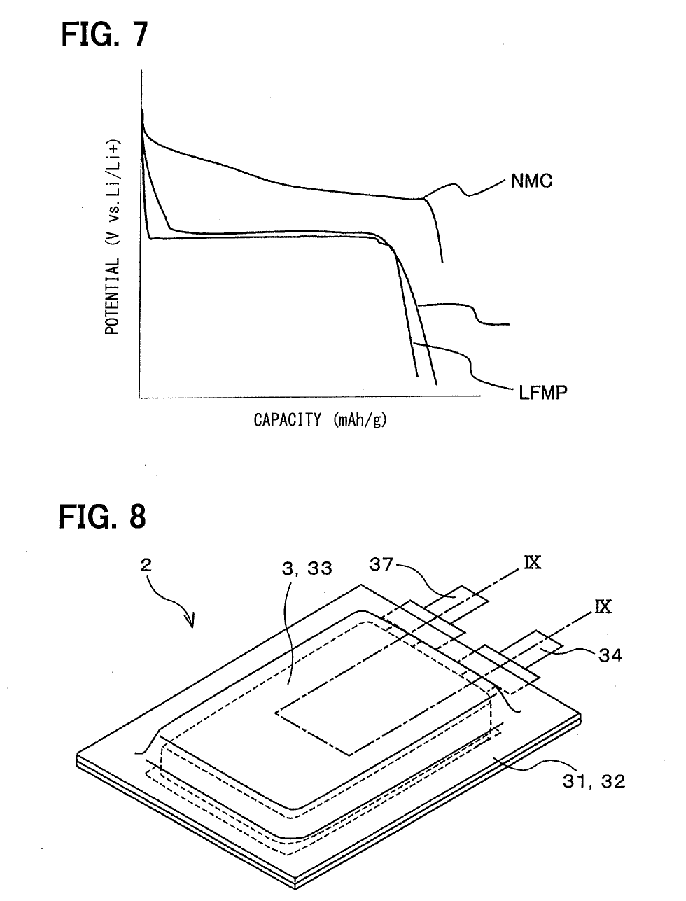

Discharge curves of LFP, NMC and a discharge curve of a mixed cathode of LFP and NMC are shown in FIG. 7. As shown in FIG. 7, the curve refers to a discharge curve of a cathode obtained by mixing LFP and NMC at a mass ratio where LFP:NMC=80:20. When discharge curves of the two cathode active materials do not intersect with each other, an improvement (buffering of a sudden drop) is found in a sudden drop of the potential of LFP in the initial and terminal phases of discharge. However, the potential of the whole cathode indicates a value that comes close to the potential of LFP, and is significantly lower than LFMP.

In addition, when the two discharge curves intersect with each other at at least two points, it is preferable that at least one intersection point of the discharge curves is present in the course of electric discharge (it is preferable that the intersection point is not present in the initial and terminal phases of electric discharge). When at least one intersection point of the discharge curves is located in the course of electric discharge, even with a cathode active material (the first cathode active material 142), which causes a sudden drop of potentials in the course of electric discharge, a sudden drop of potentials of the whole cathode in the course of electric discharge can be suppressed.

The first cathode active material 142 is preferably Li_{α}Fe_{β}M_{1-β}XO_{4-γ}Z_{γ} where 0<β≦0.4 and M is one or more selected from Mn, Cr, Co, Cu, Ni, V, Mo, Ti, Zn, Al, Ga, B and Nb. The first cathode active material 142 is the most preferably LFMP.

Li_{α}Fe_{β}M_{1-β}XO_{4-γ}Z_{γ} is a cathode active material in which a part of Fe in LFP is substituted with a metal element in the same manner as LFMP. Even when the first cathode active material 142 is such a compound whose Li diffusion resistance increases in the course of electric discharge, a sudden drop of potentials of the whole cathode in the course of electric discharge is suppressed by action of the second cathode active material 143.

It is preferable that the first cathode active material 142 is granules obtained by granulating primary particles with a particle diameter of 100 nm or less, and that an average particle diameter (D50) of granules is 15 μm or less.

By adjusting the diameter of the primary particles of the first cathode active material 142 to 100 nm or less, an increase in the Li diffusion resistance of the first cathode active material 142 can be suppressed. Specifically, the Li diffusion resistance of the first cathode active material 142 is higher, as compared with the second cathode active material 143. Therefore, in cases where the two cathode active materials 142 and 143 are mixed, it is required that diffusion of Li into the first cathode active material 142 is easily caused, and, by providing a geometric characteristic where the diameter of the primary particles is adjusted to 100 nm or less, an increase in the Li diffusion resistance is suppressed. In addition, when the diameter of the primary particles increases, the Li diffusion resistance of the first cathode active material 142 starts to excessively increase. In other words, this leads to generation of a gas on the anode of the lithium-ion secondary battery 1.

Furthermore, the first cathode active material 142 is granules obtained by granulating primary particles, and is used as granules whose average particle diameter (D50) is 15 μm or less. When the particle diameter of the primary particles reaches as small as a nanosize (100 nm or less), coagulation of the primary particles occurs, and therefore, it becomes difficult to uniformly mix the particles with the second cathode active material 143. Accordingly, by preparing the first cathode active material 142 as such granules, which are obtained by granulating primary particles, uniform mixture can be achieved. In addition, when a particle diameter of the granules becomes excessively large, Li diffusion into the center of granulated particles hardly occurs, and, as a result, the Li diffusion resistance of the first cathode active material 142 starts to excessively increase.

In cases where the first cathode active material 142 is granules, a method of granulating primary particles into granules is not limited. For example, granulation can be carried out by mixing granulation methods such as the spray dry method, the rolling granulation method, the centrifugal rolling granulation method, the fluidized-bed granulation method, the agitation granulation method, and mechanical milling.

The second cathode active material 143 is preferably Li_{γ}M′_{z}O₂ where 0.05<y<1.20; 0.7≦z≦1.1; and M′ is one or more selected from Ni, Mn, Fe, Cr, Co, Cu, V, Mo, Ti, Zn, Al, Ga, B and Nb, and the second cathode active material 143 preferably has an average particle diameter (D50) of 10 μm or less.

The second cathode active material 143 is not limited as long as the second cathode active material 143 is a compound that has a lithium diffusion coefficient different from that of the first cathode active material 142 and that has a layered rock salt-type structure. However, when the second cathode active material 143 is formed of such a compound, the above-mentioned effects can be obtained.

For the second cathode active material 143, LiNiMnCoO₂ (M′ is Ni, Mn and Co; Ni+Mn+Co=z=1; and y=1), LiNiCoO₂ (M′ is Ni and Co; Ni+Co=z=1; and y=1), LiNiMnO₂ (M′ is Ni and Mn; Ni+Mn=z=1; and y=1), LiCoO₂ (M′ is Co; z=1; and y=1), and LiNiO₂ (M′ is Ni; z=1; and y=1) are preferable.

For the cathode active material, those having the first cathode active material 142 and the second cathode active material 143 can be employed. Furthermore, the cathode active material may have a third cathode active material. The third cathode active material may be either another substance that is included in each of the above-described chemical formulas for the cathode active materials 142 and 143, or a compound other than the another substance.

The cathode active material more preferably consists of the first cathode active material 142 and the second cathode active material 143.

When a mass of the whole cathode active material is regarded as 100%, it is preferable that 40% or less of the second cathode active material 143 is included therein. When 40% or less of the second cathode active material 143 is included therein, a sudden drop of the potential of the first cathode active material 142 in the course of electric discharge can be suppressed. The second cathode active material 143 more easily causes deterioration of battery characteristics than the first cathode active material 142 does. Therefore, when more than 40% of the second cathode active material 143 is included therein, the cycle characteristic of the lithium-ion secondary battery 1 is likely to deteriorate.

A battery capacity (CA) of the first cathode active material 142 is preferably equal to or lower than a battery capacity (CB) of the second cathode active material 143 (CA≦CB). Battery capacities CA and CB of the cathode active materials 142 and 143 each correspond to end points of discharge curves shown in FIG. 2. Additionally, as shown in FIG. 2, discharge curves of both the cathode active materials rapidly decrease in the terminal phase of electric discharge, and comparison of CA and CB may be carried out with respect to any potentials in the terminal phase of electric discharge.

When the battery capacity CB of the second cathode active material 143 becomes equal to or more than the battery capacity CA of the first cathode active material 142, the second discharge curve grows larger than the first discharge curve in a region corresponding to the plateau region of the first discharge curve present at the higher capacity side. In other words, even when a rapid change of potential is caused in the first cathode active material 142 in the course of electric discharge, a drop of potential of the whole cathode active material is suppressed because the potential of the second cathode active material 143 is higher than the potential of the first cathode active material 142. That is, the above-mentioned effects can definitely be exerted.

Furthermore, when the battery capacity CB of the second cathode active material 143 becomes excessively lower than the battery capacity CA of the first cathode active material 142, electric discharge will occur beyond the battery capacity CB of the second cathode active material 143, and a damage (structural collapse) of the second cathode active material 143 may be caused.

It is preferable that an Li-ion diffusion coefficient KA of the first cathode active material 142 and an Li-ion diffusion coefficient KB of the second cathode active material 143 have the relation log(KA/KB)≧6. There is a difference of more than six figures between the ion diffusion coefficients of the two cathode active materials 142 and 143. When such a large difference of the diffusion coefficients is present, the above-mentioned effects will particularly be exerted.

Specifically, LNO and LCO of a layered rock salt-type structure (α-NaFeO₂-type structure) have a diffusion coefficient of 1×10⁻⁸ cm²/s to 1×10⁻⁶ cm²/s. In addition, it has been reported that LiMn₂O₄, LiCoMnO₄, Li₂NiMn₃O₈, which have a spinel structure, have a diffusion coefficient of 1×10⁻¹⁰ cm²/s to 1×10⁻⁷ cm²/s. On the other hand, it has been known that diffusion coefficients of LFP and LFMP, which have a polyanion structure, are 1×10⁻¹⁴ cm²/s or less. When a difference of six or more figures is present between the ion diffusion coefficients of the two cathode active materials 142 and 143 in such a way, Li diffusion into the first cathode active material 142, into which Li ions are difficult to diffuse, is assisted by the second cathode active material 143, thereby suppressing an increase of the resistance of the whole cathode active material.

(Structure Other than the Cathode Active Material)

In the lithium-ion secondary battery 1 according to the present embodiment, a structure other than use of the above-described cathode active materials can be arranged in the same manner as existing lithium-ion secondary batteries.

(Cathode)

With regard to the cathode 14, a cathode mixture, which has been obtained by mixing cathode active materials, a conductive material and a binder, is coated onto the cathode collector 140 to thereby provide the cathode mixture layer 141.

The conductive material ensures electric conductivity of the cathode 14. For the conductive material, carbon black such as fine particles of graphite, acetylene black, Ketjen black and carbon nanofibers; fine particles of amorphous carbon such as needle coke; and the like can be used. However, the conductive material is not limited thereto.

The binder binds particles of cathode active materials, or a conductive material. For the binder, for example, PVDF, EPDM, SBR, NBR, a fluorine rubber, and the like can be used. However, the binder is not limited thereto.

The cathode mixture is dispersed in a solvent, and then, is coated onto the cathode collector 140. For the solvent, organic solvents that dissolves the binder are generally used. For example, NMP, dimethylformamide, dimethylacetamide, methyl ethyl ketone, cyclohexanone, methyl acetate, methyl acrylate, diethyl triamine, N—N-dimethylaminopropylamine, ethylene oxide, tetrahydrofuran, and the like can be mentioned. However, the solvent is not limited thereto. In addition, there is a case in which a dispersing agent, a thickening agent, etc. are added to water, and the cathode active material is formed into a slurry with PTFE or the like.

For the cathode collector 140, for example, those obtained by processing a metal such as aluminum or stainless steel, e.g. foils obtained by processing a metal into a plate, a mesh, a punched metal, a formed metal, and the like can be used. However, the cathode collector is not limited thereto.

(Non-Aqueous Electrolyte)

For the non-aqueous electrolyte 13, those obtained by dissolving a supporting salt in an organic solvent is used.

A type of the supporting salt for the non-aqueous electrolyte 13 is not particularly limited. However, the supporting salt is preferably at least one of an inorganic salt selected from LiPF₆, LiBF₄, LiClO₄ and LiAsF₆; a derivative of the inorganic salt; an organic salt selected from LiSO₃CF₃, LiC(SO₃CF₃)₃, LiN(SO₂CF₃)₂, LiN(SO₂C₂F₅)₂, and LiN(SO₂CF₃)(SO₂C₄F₉); and a derivative of the organic salt. These supporting salts can make battery performance more excellent, and can maintain the battery performance at a higher level even in a temperature region other than room temperature. A concentration of the supporting salt is not particularly limited, and it is preferable that the concentration is properly selected in consideration of types of the supporting salt and the organic solvent, depending on the purpose.

The organic solvent (nonaqueous solvent) in which the supporting salt is dissolved is not particularly limited as long as it is an organic solvent that is generally used for non-aqueous electrolytes. For example, carbonates, halogenated hydrocarbons, ethers, ketones, nitriles, lactones, oxolane compounds, and the like can be used. In particular, propylene carbonate, ethylene carbonate, 1,2-dimethoxyethane, dimethyl carbonate, diethyl carbonate, ethyl methyl carbonate, vinylene carbonate, and the like; as well as a mixture solvent obtained by mixing them are suitable. In particular, one or more types of non-aqueous solvents selected from the group consisting of carbonates and ethers among the organic solvents mentioned as examples are preferable because the non-aqueous solvents are excellent in terms of solubility of the supporting salt, electric permittivity and viscosity, and provide excellent charge/discharge efficiency of the battery.

In the lithium-ion secondary battery 1 according to the present embodiment, the most preferable non-aqueous electrolyte 13 is a non-aqueous electrolyte obtained by dissolving a supporting salt in an organic solvent.

(Anode)

In the anode 17, an anode mixture, which has been obtained by mixing an anode active material and a binder, is coated onto the surface of an anode collector 170 to thereby provide the anode mixture layer 171.

For the anode active material, an existing anode active material can be used. As the anode active material, an anode active material containing at least one element of Ti, Sn, Si, Sb, Ge, and C can be mentioned.

In the lithium-ion secondary battery 1 of the present embodiment, the anode active material is preferably an anode active material with an Li/Li⁺ potential of 2 V or less, and is more preferably an anode active material with an Li/Li⁺ potential of 0.5 V to 2 V.

A battery voltage of the lithium-ion secondary battery 1 is determined by a difference between an Li/Li⁺ potential of the cathode active material and an Li/Li⁺ potential of the anode active material. In general, an Li/Li⁺ potential of a cathode active material is larger than an Li/Li⁺ potential of an anode active material.

Therefore, when the Li/Li⁺ potential of the anode active material is 2 V or less, a sufficient difference between the Li/Li⁺ potentials of the cathode and anode active materials can be obtained. In other words, the lithium-ion secondary battery 1 of the present embodiment can secure sufficient battery voltage (battery capacity) as a lithium-ion secondary battery.

Moreover, when the potential difference between the cathode active material and the anode active material grows large, a variation of potentials from a potential of the cathode active material to a potential of the anode active material will be large, and it takes a long time for the potential variation (electric discharge). In other words, the internal resistance increases. In particular, when a potential of the cathode active material rapidly decreases, a significant increase in the resistance occurs. Therefore, the anode active material more preferably has an Li/Li⁺ potential of 0.5 V or higher.

In other words, the anode active material preferably has an Li/Li⁺ potential of 0.5 V to 2 V.

Among the above-described anode active materials, anode active materials containing C are anode active materials with an Li/Li⁺ potential of 2 V or less. Specifically, the anode active materials containing C are preferably carbon materials (graphite) that can store/eliminate electrolyte ions of the lithium-ion secondary battery 1 (capable of Li storage), and are more preferably amorphous material-coated graphite.

Moreover, among the above-described anode active materials, anode active materials containing Si, Sn, Sb or Ge are anode active materials with an Li/Li⁺ potential of 2 V or less. Such anode active materials containing Si, Sn, Sb or Ge are particularly alloy materials that exhibit large volume changes. These anode active materials may form alloys with other metals, such as Ti—Si, Ag—Sn, Sn—Sb, Ag—Ge, Cu—Sn and Ni—Sn.

Furthermore, as anode active materials containing Ti among these anode active materials, titanium-containing metal oxides can be mentioned. The titanium-containing metal oxides are anode active materials with an Li/Li⁺ potential of 0.5 V to 2 V. As such titanium-containing metal oxides, a lithium titanium oxide, a titanium oxide, and a niobium-titanium composite oxide can be mentioned.

As the lithium-titanium oxide, Li₄₊ₓTi₅O₁₂ (−1≦x≦3) of a spinel structure, or Li₂₊ₓTi₃O₇ (−1≦x≦3) of a ramsdellite structure can be mentioned.

As the titanium oxide, TiO₂ of an anatase structure, or monoclinic TiO₂(B) can be mentioned. For TiO₂(B), those heat-treated within a range of 300° C. to 500° C. are preferable. TiO₂(B) preferably contains 0.5% to 10% by weight of Nb. According to this, a capacity of the anode can be made higher. Irreversible lithium may remain in a titanium oxide after charge/discharge is carried out with respect to a battery, and therefore, such a titanium oxide after charge/discharge is carried out to the battery can be represented by Li_{d}TiO₂ (0<d≦1)

As the niobium-titanium composite oxide, LiₓNbₐTi_{b}O_{c} (0≦x≦3; 0<a≦3; 0<b≦3; and 5≦c≦10) can be mentioned. Examples of LiₓNbₐTi_{b}O_{c} include LiₓNb₂TiO₇, LiₓNb₂Ti₂O₉ and LiₓNbTiO₅. LiₓTi_{1-y}Nb_{y}Nb₂O_{7+σ} (0≦x<3; 0≦y≦1; and which has been heat-treated at 800° C. to 1,200° C. has a higher real density, and can increase the volume specific capacity. LiₓNb₂TiO₇ is preferable because the compound has a high density and a high capacity. This can make the anode capacity higher. Furthermore, a part of Nb or Ti of the above-described oxides may be replaced with at least one element selected from the group consisting of V, Zr, Ta, Cr, Mo, W, Ca, Mg, Al, Fe, Si, B, P, K and Na.

It is preferable that at least one part of the surface of the titanium-containing metal oxide is coated with a carbon material, in the same manner as the case of C. This enhances an electron-conducting network inside the electrode, and the electrode resistance is reduced, thereby improving the large-current performance.

With regard to the anode active material (preferably a Ti-containing anode active material), its specific surface area by the BET method based on N₂ adsorption (BET specific surface area) is preferably 30 m²/g or less. When the BET specific surface area is 30 m²/g or less, the non-aqueous electrolyte can uniformly be dispersed in the cathode and the anode, thereby improving output characteristics and charge/discharge cycle characteristics.

Moreover, when the BET specific surface area exceeds 30 m²/g, water included in the lithium-ion secondary battery 1 produces a gas. Furthermore, HF is produced, and the produced HF elutes Mn included in the cathode active material, and deteriorations (reduction in the durability) of the cathode (cathode active material) are caused.

With regard to the anode active material (preferably a Ti-containing anode active material), its BET specific surface area based on N₂ adsorption is preferably 3 m²/g or more. When the BET specific surface area is 3 m²/g or more, coagulation of particles of the anode active material can be reduced, affinity between the anode 17 and the non-aqueous electrolyte 13 can be made high and interfacial resistance of the anode 17 can be made small. As a result, output characteristics and charge/discharge cycle characteristics can be improved.

A more preferable range for the BET specific surface area of the anode active material (preferably a Ti-containing anode active material) is 5 to 50 m²/g.

With regard to the anode active material (preferably a Ti-containing anode active material), a primary particle diameter (average particle diameter) hereof is preferably 1 μm or less. When the primary particle diameter is 1 μm or less, affinity between the anode 17 and the non-aqueous electrolyte 13 can still be made higher. Furthermore, a side reductive reaction of the non-aqueous electrolyte 13 under a high-temperature environment can be suppressed, and high-temperature cycle life performance and heat stability can be enhanced.

For the conductive material, carbon materials, metal powder, conductive polymers and the like can be used. In terms of conductivity and stability, carbon materials such as acetylene black, Ketjen black, and carbon black are preferably used.

As the binder, polytetrafluoroethylene (PTFE), polyvinylidene fluoride (PVDF), fluororesin copolymers (tetrafluoroethylene/hexafluoropropylene copolymers), SBR, acrylic rubbers, fluoro rubbers, polyvinyl alcohol (PVA), styrene/maleic acid resins, polyacrylates, carboxymethylcellulose (CMC), and the like can be mentioned.

As the solvent, organic solvents such as N-methyl-2-pyrrolidone (NMP), water, and the like can be mentioned.

As the anode collector 170, an existing collector can be used, and those obtained by processing a metal such as copper, stainless steel, titanium or nickel, e.g. foils obtained by processing a metal into a plate, a mesh, a punched metal, a formed metal, and the like can be used. However, the anode collector 170 is not limited thereto.

(Other Structure)

The cathode case 11 and the anode case 16 seal built-in components through an insulating seal material 12. The built-in components are the non-aqueous electrolyte 13, the cathode 14, the separator 15, the anode 17, the holding member 18, etc.

The cathode mixture layer 141 is in surface contact with the cathode case 11 through the cathode collector 140 to achieve conduction. The anode mixture layer 171 is in surface contact with the anode case 17 through the anode collector 170.

The separator 15 that intervenes between the cathode mixture layer 141 and the anode mixture layer 171 electrically insulates the cathode mixture layer 141 and the anode mixture layer 171, and retains the non-aqueous electrolyte 13. For the separator 15, for example, a porous synthetic resin membrane, in particular, a porous membrane of a polyolefin-based polymer (polyethylene or polypropylene) is used. The separator 15 is formed at a dimension larger than the two mixture layers 141 and 171 to secure electrical insulation of the mixture layers 141 and 171.

The holding member 18 has a role in holding the cathode collector 140, the cathode mixture layer 141, the separator 15, the anode mixture layer 171, and the anode collector 170 at fixed positions. When an elastic material such as an elastic piece or spring is used therefor, it is easy to hold them at fixed positions.

As to the lithium-ion secondary battery 1 of the present embodiment, the lower limit voltage is preferably a voltage smaller than the operation voltage by 0.5 to 1.5 (V). By setting the lower limit voltage to the operation voltage or lower (a predetermined value or predetermined range based on the operation voltage), a voltage reduction that make the voltage to go below the lower limit voltage (the lower limit voltage or lower) can be suppressed. According to the lithium-ion secondary battery 1 of the present embodiment, over discharge will be suppressed.

Specifically, when the lithium-ion secondary battery 1 of the present embodiment undergoes electric discharge, the battery voltage decreases. As the battery voltage continues to decrease, the battery voltage reaches a predetermined value of lower limit voltage. When electric discharge further proceeds, electric discharge in a state where the voltage value is maintained at a value of the lower limit voltage is carried out. At that time, the current value is reduced. According to the lithium-ion secondary battery 1 of the present embodiment, by setting a value of the lower limit voltage, over discharge will be suppressed.

Control of the lower limit voltage in the lithium-ion secondary battery 1 of the present embodiment is carried out by a controlling unit (controller) that is not shown in figures.

### Second Embodiment

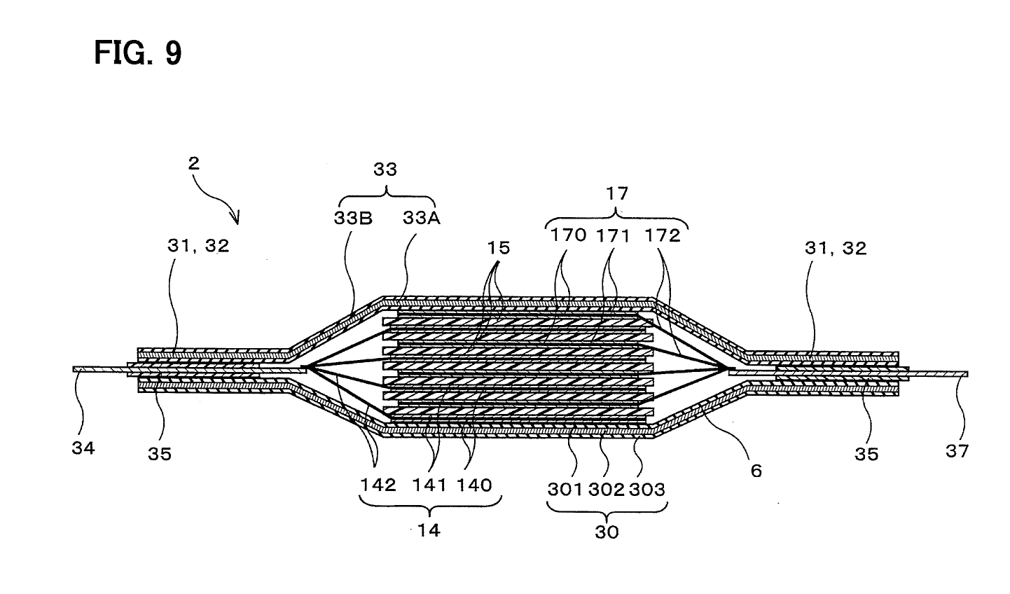

A lithium-ion secondary battery 2 of the present embodiment is formed by placing the cathode 14 and the anode 17 in a battery case 3 made of a laminate case. In addition, any structure that is not particularly limited in the present embodiment can be arranged in the same manner as the first embodiment. A structure of the lithium-ion secondary battery 2 of the present embodiment is shown in FIG. 8 based on a perspective view, and in FIG. 9 based on a cross-section view along the line IX-IX of FIG. 8.

(Cathode)

The cathode 14 is formed by forming the cathode mixture layer 141 on surfaces (both sides) of the nearly square cathode collector 140. The cathode 14 has an uncoated part 142 (where the cathode mixture layer 141 is not provided) that is formed by exposing the cathode collector 140 on one side of the square-shaped structure.

(Anode)

The anode 17 is formed by forming the anode mixture layer 171 on surfaces (both sides) of the nearly square anode collector 170. The anode 17 has an uncoated part 172 (where the anode mixture layer 171 is not provided) that is formed by exposing the anode collector 170 exposed on one side of the square-shaped structure.

In the anode 17, the anode mixture layer 171 is formed more widely than the cathode mixture layer 141 of the cathode 14. The anode mixture layer 171 of the anode 17 is formed in a size that allows the anode mixture layer 171 to completely cover the cathode mixture layer 141 and that prevents the cathode mixture layer 141 from being exposed thereon when the cathode mixture layer 171 is layered over the cathode mixture layer 141.

The cathode 14 and the anode 17 are placed (encapsulated), together with a non-aqueous electrolyte 13, in a laminate case, which has been formed from a laminate film, in a state where the cathode 14 and the anode 17 are layered through the separator 15. The number of cathodes 14, anodes 17 and separators 15 laminated therein can voluntarily be set to 1 or more, and it is preferable that they are plural layers.

The separator 15 is formed in an area broader than the anode mixture layer 171.

The cathode 14 and the anode 17 are layered through the separator 15 in a state where the centers of the cathode mixture layer 141 and the anode mixture layer 171 overlap with each other. In this case, the uncoated part 142 of the cathode 14 and the uncoated part 172 of the anode 17 are disposed in the same direction. Additionally, in a state where the cathode 14 and the anode 17 are layered, the uncoated part of the cathode 14 and the uncoated part 172 of the node 17 are each formed so as to protrude from one end part in the lateral direction and from the other end part in the lateral direction, respectively.

(Battery Case)

The battery case 3 (laminate case) is formed from a laminate film. A laminate film 30 includes a plastic resin layer 301/a metal foil 302/a plastic resin layer 303 in this order. By pressing the laminate film 30, which has preliminarily been bent into a predetermined shape, to another laminate film or the like in a state where the plastic resin layers 301 and 303 are softened by heat or with some sort of solvent, the battery case 3 is bonded to the another laminate film.

The laminate films 30, which have preliminarily been formed (embossed) into a shape which can store the cathode 14 and the anode 17, are overlapped, and edge parts of the outer periphery thereof are bonded over the entire periphery, and the cathode 14 and the anode 17 are encapsulated inside it, thereby forming the battery case 3 (laminate case). Bonding of the outer periphery forms sealing parts. Bonding of the outer periphery is carried out by fusion in the present embodiment.

The battery case 3 is formed by overlapping another laminate film 30 on the laminate film 30. In this case, the another laminate film 30 refers to a laminate film which is to be bonded (fused). In other words, the battery case 3 includes not only an embodiment in which the battery case 3 is formed from two or more pieces of laminate films, but also an embodiment in which the battery case 3 is formed by folding one piece of the laminate film.

Bonding (assembling) of the outer periphery of the battery case 3 is carried out under a reduced-pressure atmosphere (preferably vacuum). Accordingly, the atmosphere (water included therein) is not included inside the battery case 3, and only a power storage element (a laminate of the electrodes 14 and 17) is encapsulated in the battery case 3.

As shown in FIGS. 8 to 9, when the laminate films 30, which have preliminarily been formed, are overlapped, the laminate films 30 have tabular parts 31 that each form sealing parts 32 between the one laminate film and the other laminate film, as well as a trough-shaped part 33 that can store the cathode 14 and the anode 17 and that is formed in a central part between the tabular parts 31.

As shown in FIGS. 8 to 9, a pair of laminate films 30 and 30 are bent (formed) so as to form a concave shape which is capable of storing the cathode 14 and the anode 17. The laminate films 30 and 30 have the same shape, and, when they are layered in a direction where they face to each other, the tabular parts 31 and 31 are completely overlapped.

In the laminate film 30, the tabular part 31 and a bottom part 33A of the trough-shaped part 33 (a part that forms an end part in the laminated direction of the lithium-ion secondary battery 2) are formed parallel to one another. The tabular part 31 and the bottom part 33A of the trough-shaped part 33 are connected with each other through an erected part 33B. The erected part 33B extends to a direction (inclination direction) that intersects the direction parallel to the tabular part 31 and the bottom part 33A. The bottom part 33A is formed in a size smaller than an opening (an inward end part of the tabular part 31) of the trough-shaped part 33.

In battery case 3 (laminate case), the sealing parts 32 are formed at edge parts of the tabular parts 31 and 31, and an unbonded portion, where the tabular parts 31 and 31 are overlapped, is formed at an inward portion of the sealing parts 32 (in the direction close to power storage elements (the laminate of electrodes 14 and 17)). The unbonded portion where the tabular parts 31 and 31 are overlapped may be either in a state where the tabular parts 31 and 31 are in contact with one another or in a state where a gap is formed between them. Furthermore, uncoated parts 142 and 173 of electrodes 14 and 17 as well as the separator 15 may be present in the unbonded portion.

The laminate films 30 and 30 have preliminarily been formed into a shape shown in FIGS. 8 to 9. Conventionally-known forming methods are used for forming into the shape.

As for the lithium-ion secondary battery 1 of the present embodiment, the cathode 14 and the anode 17 are each connected to electrode terminals (a cathode terminal 34 and an anode terminal 37).

(Electrode Terminal)

The cathode terminal 34 is electrically connected to the uncoated part 142 of the cathode 14. The anode terminal 37 is electrically connected to the uncoated part 172 of the anode 17. In the present embodiment, the uncoated parts 142 and 172 of the electrodes 14 and 17 are each joined to the electrode terminals 34 and 37 by welding (vibration welding). Central portions of the width direction of the uncoated parts 142 and 172 of the electrodes 14 and 17 are each joined to the electrode terminals 34 and 37.

The electrode terminals 34 and 37 are each joined to the plastic resin layers 301 of the laminate films 30 and 30 through sealants 35 so as to maintain a sealed state of the plastic resin layers 301 of the laminate films 30 and 30 and the electrode terminals 34 and 37 in portions where the electrode terminals 34 and 37 each penetrate into the battery cases 3.

The electrode terminals 34 and 37 are made of a sheet (foil) metal, and the sealants 35 are made of a resin that covers the sheet-like electrode terminal 34 and 37. The sealants 35 cover portions where the electrode terminals 34 and 37 overlap with the tabular parts 31. Deforming stress of the laminate films 30 due to the presence of the electrode terminals 34 and 37 in the portions where electrode terminals 34 and 37 penetrate into the battery case 3 can be reduced by shaping the electrode terminals 34 and 37 into sheets. Additionally, welding (vibration welding) of the uncoated parts 142 and 172 of the electrodes 14 and 17 can easily be carried out.

The lithium-ion secondary battery 2 of the present embodiment has the same structure as the lithium-ion secondary battery 1 of the first embodiment, except that the shapes of the batteries are different from each other, and exerts the same effects.

In other words, a shape of a lithium-ion secondary battery of the disclosure is not particularly limited. That is, the lithium-ion secondary battery of the disclosure can be arranged as batteries of various types of shapes, such as a cylindrical or square type, besides the coin-type lithium-ion secondary battery 1 of the first embodiment and the laminate case-type irregular-shape lithium-ion secondary battery 2 of the second embodiment.

### Third embodiment

The present embodiment refers to an assembled battery system that is formed by combining plural lithium-ion secondary batteries 1 and 2.

The assembled battery system of the present embodiment is formed by connecting the plural lithium-ion secondary batteries 1 or the plural lithium-ion secondary batteries 2 in series and/or parallel. The assembled battery system of the present embodiment has a series connection body in which the plural lithium-ion secondary batteries 1 or the plural lithium-ion secondary batteries 2 are connected in series.

A lower limit voltage of the assembled battery system of the present embodiment can be determined from a lower limit voltage of each of the lithium-ion secondary batteries 1 or 3 that form the assembled battery system.

For example, the lower limit voltage of the series connection body can be set to a sum of lower limit voltages of the respective lithium-ion secondary batteries 1 or 3. In this case, the lower limit can be set to (a lower limit voltage of the lithium-ion secondary battery 1 or 3)×(the number of the lithium-ion secondary batteries 1 or 3 connected in series).

The assembled battery system of the present embodiment is formed by combining the lithium-ion secondary batteries 1 or 3 of the first embodiment or the second embodiment, and therefore, exerts the same effects.

### Examples

Hereinafter, the disclosure will be described with reference to examples.

As examples for specifically describing the disclosure, cathode active materials (first cathode active materials) and lithium-ion secondary batteries using them were produced. In the examples, the above-described lithium-ion secondary batteries shown in FIGS. 1 and 8 to 9 were produced.

[First Cathode Active Material]

As materials for cathode active materials, an Li source: Li₂SO₄; a P source: (NH₄)₂HPO₄; a Co source: CoSO₄.7H₂O; an Mn source: MnSO₄.5H₂O; an Fe source: FeSO₄.7H₂O; and a C source: CMC (solid content: 6%) were prepared.

The prepared compounds, namely materials, were each weighed so as to formulate compositions shown in Table 1, and were wet-mixed.

Then, a hydrothermal synthesis (200° C., 1 hour) and a dehydration treatment were carried out.

After the dehydration treatment, the C source was mixed thereto, and the resulting mixtures were baked (200° C., 1 hour) to produce cathode active materials A1 to A5 (the first cathode active material 142). In addition, the baked cathode active materials A1 to A5 were granulated when appropriate. Furthermore, samples, in which coagulation of particles was observed after the C source was mixed thereto, were crashed before baking them.

When structures of the produced cathode active materials A1 to A5 were observed, it was confirmed that, for all the cathode active materials, primary particles of 100 nm or less were granulated in a such way that the average particle diameter (D50) became 20 μm or less.

TABLE 1

| | | | | | | | Particle |
|---|---|---|---|---|---|---|---|
| | | | | | | Primary | diameter |
| Names of | Active | | Atomic | | | particle | D50 of |
| active | material | | proportion | | | diameter | granules |
| materials | species | Chemical formula | Fe | Mn | Co | (nm) | (μm) |
| Cathode | LFMP | LiFe_{0.4}Mn_{0.6}PO₄ | 40 | 60 | 0 | 100 or less | 20 or less |
| active | | | | | | | |
| material A1 | | | | | | | |
| Cathode | LFMP | LiFe_{0.2}Mn_{0.8}PO₄ | 20 | 80 | 0 | 100 or less | 20 or less |
| active | | | | | | | |
| material A2 | | | | | | | |
| Cathode | LMP | LiMnPO₄ | 0 | 100 | 0 | 100 or less | 20 or less |
| active | | | | | | | |
| material A3 | | | | | | | |
| Cathode | LCFMP | LiFe_{0.4}Mn_{0.45}Co_{0.1}PO₄ | 40 | 45 | 10 | 100 or less | 20 or less |
| active | | | | | | | |
| material A4 | | | | | | | |
| Cathode | LFP | LiFePO₄ | 100 | 0 | 0 | 100 or less | 20 or less |
| active | | | | | | | |
| material A5 | | | | | | | |

[Second Cathode Active Material]

Cathode active materials B1 to B3 shown in Table 2 were prepared. All of the prepared cathode active materials B1 to B3 had an average particle diameter (D50) of 2 to 10 μM.

TABLE 2

| | | | | | | Average |
|---|---|---|---|---|---|---|
| Names of | Active | | Atomic | | | Particle |
| active | material | | proportion | | | diameter |
| materials | species | Chemical formula | Ni | Mn | Co | D50 (μm) |
| Cathode | NMC | LiNi_{1/3}Mn_{1/3}Co_{1/3}O₂ | ⅓ | ⅓ | ⅓ | 2-10 |
| active | | | | | | |
| material B1 | | | | | | |
| Cathode | NMC | LiNi_{0.4}Mn_{0.4}Co_{0.2}O₂ | 0.4 | 0.4 | 0.2 | 2-10 |
| active | | | | | | |
| material B2 | | | | | | |
| Cathode | LCO | LiNCoO₂ | 0 | 0 | 1 | 2-10 |
| active | | | | | | |
| material B3 | | | | | | |

[Diffusion Coefficient]

Li diffusion coefficients of the cathode active materials A1 to A5 and the cathode active materials B1 to B3 are described above. That is, Li-ion coefficients KA of cathode active materials A1 to A5 and Li-ion coefficients KB of cathode active materials B1 to B3 have the relation log(KA/KB)≧6.

[Evaluation 1]

By using the above cathode active materials A1 to A5 and cathode active materials B1 to B3, test cells (coin-type half cells or laminate-type cells) were assembled and evaluated.

(Coin-Type Half Cells)

The test cells (coin-type half cells) had the same structure as the coin-type lithium-ion secondary battery 1 whose structure is shown in FIG. 1.

For a cathode, each cathode mixture, which was obtained by mixing 91 parts by mass of each cathode active material, 2 parts by mass of acetylene black and 7 parts by mass of PVDF, was coated onto the cathode collector 140 made of an aluminum foil to form the cathode mixture layer 141 thereon, and the resulting product was used. Those obtained by mixing the cathode active materials A1 to A5 and the cathode active materials B1 to B3 at mass ratios shown in Table 3 were used as cathode active materials.

Metal lithium was used for an anode (counter electrode). The metal lithium corresponds to the anode mixture layer 171 in FIG. 1.

For the non-aqueous electrolyte 13, a product prepared by dissolving LiPF₆ in a mixture solvent of 30 vol % of ethylene carbonate (EC) and 70 vol % of diethyl carbonate (DEC) at 1 mol/L was used.

After being assembled, the test cells were subjected to an activation treatment by charging/discharging of ⅓ C×2 cycles.

As described above, test cells (half cells) for the respective test examples were produced.

TABLE 3

| | | | | Numbers of | |
|---|---|---|---|---|---|
| | | | | intersection | |
| | Cathode active | Cathode active | Blending ratios | points of | Resistance |
| | material | material | of cathode active | discharge | ratios |
| | species A | species B | materials A/B | curves | (%) |
| Test Example 1 | A1 | B1 | 60/40 | 2 | 64 |
| Test Example 2 | (Fe: 40%) | — | 100/0 | — | 100 |
| Test Example 3 | A2 | B1 | 60/40 | 2 | 24 |
| Test Example 4 | (Fe: 20%) | — | 100/0 | — | 100 |
| Test Example 5 | A3 | B1 | 60/40 | 2 | 46 |
| Test Example 6 | (Fe: 0%) | — | 100/0 | — | 100 |
| Test Example 7 | A4 | B1 | 60/40 | 3 | 84 |
| Test Example 8 | (Fe: 40%) | — | 100/0 | — | 100 |
| Test Example 9 | A5 | B1 | 60/40 | 0 | 102 |
| Test Example 10 | (Fe: 100%) | — | 100/0 | — | 100 |

The numbers of intersection points of discharge curves in Table 3 show numbers of intersection points of respective discharge curves in cases where discharge curves of cathode active materials A and B are shown together (shown in the same manner as the case of FIG. 2) with respect to Test Examples 1, 3, 5, 7 and 9 in which cathode active materials A and B were mixed. Additionally, in Test Example 9 in which the number of intersection points was zero, the potential of LFP was lower as shown in FIGS. 6 to 7.

Furthermore, in Test Examples 1, 3, 5, 7 and 9, for discharge curves of cathode active materials A and B, battery capacities CA of cathode active materials A were equal to or less than battery capacities CB of cathode active materials B (CA≦CB) as exemplified in FIG. 2.

[Resistance Measurement]

For each test cell, the SOC was adjusted to a predetermined value. The predetermined value refers to a proportion of Fe (atomic proportions in Table 1) in a cathode active material A (A1 to A5). In addition, in cases of the cathode active material A3 (Fe: 0) and the cathode active material A5 (Fe: 100), a SOC of 50% was used as a predetermined value.

Electric discharge was carried out at each of discharge rates 0.2/1/3/5/7 C, and a resistance value was obtained from a voltage change (inclination) at 10 sec. Each of ratios of resistance values (resistance ratios) when a resistance value in a case where any cathode active material B1 was not contained was regarded as 100% is shown in Table 3.

Specifically, in table 3, the resistance value of Test Example 1 is shown as a ratio when the resistance value of Test Example 2 is regarded as 100%, the resistance value of Test Example 3 is shown as a ratio when the resistance value of Test Example 4 is regarded as 100%, the resistance value of Test Example 5 is shown as a ratio when the resistance value of Test Example 6 is regarded as 100%, and resistance values of subsequent test examples are also shown in the same manner in Table 3.

As shown in Table 3, in test cells of Test Examples 1, 3, 5 and 7 in which respective discharge curves of cathode active materials A and B intersect with each other at two or more points, their resistance ratios are lower, compared with test cells of Test Examples 2, 4, 6 and 8. That is, by using cathode active materials in which two types of cathode active materials A and B were mixed to allow the discharge curves to intersect with each other at two or more points, effects to reduce the cathode resistance (internal resistance) were exerted.

In addition, as for Test Example 9, discharge curves of cathode active materials A and B do not intersect with each other (the number of intersection points: 0), and any effects to reduce the cathode resistance in the course of the electric discharge could not be obtained.

[Potential Change]

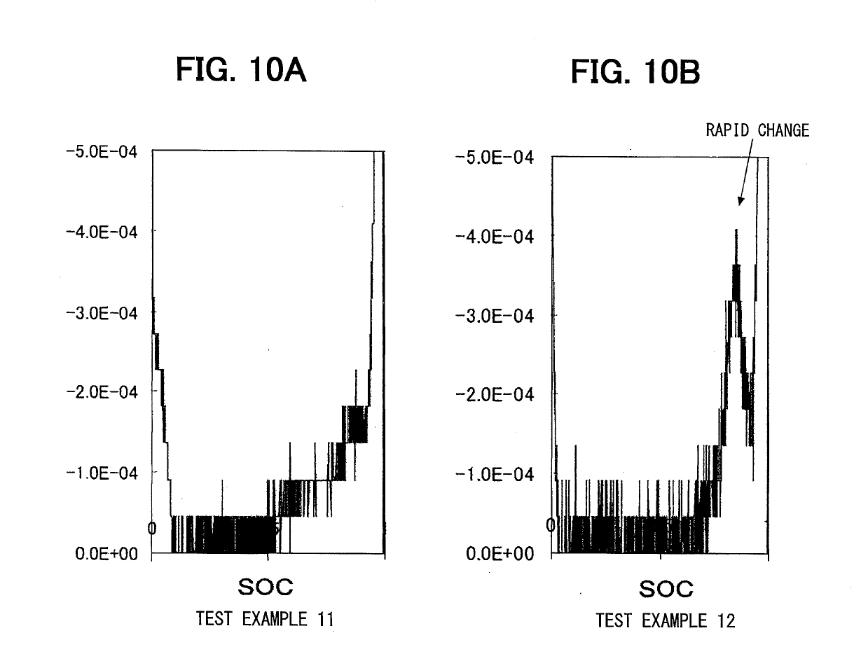

Cathode active materials A2 and B2 were used at mass ratios shown in Table 4 to assemble test cells (the same structure as the above-described coin-type half cells), and potential changes (ΔV/Δt) of the cathodes were measured. The results are shown in FIGS. 10A and 10B.

TABLE 4

| | Cathode active | Cathode active | Blending ratios |
|---|---|---|---|
| | material | material | of cathode active |
| | species A | species B | materials A/B |
| Test Example 11 | A2 | B2 | 60/40 |
| Test Example 12 | (Fe: 40%) | — | 100/0 |

As shown in FIGS. 10A and 10B, in Test Example 11 in which the cathode active material B2 was mixed, any rapid changes in the intermediate part of the SOC are not recognized. On the other hand, in Test Example 12 in which the cathode active material B2 was not mixed, rapid changes in the intermediate part of the SOC can be recognized. This indicates that, by mixing two types of cathode active materials A2 and B2, NMC, which has a small ion diffusion resistance, selectively assists ion diffusion in a boundary region where the ion diffusion resistance rapidly grows large.

[Evaluation of Primary Particle Diameters of First Cathode Active Materials]

By granulating the cathode active material A2 so as to have primary particle diameters shown in Table 5, cathode active materials A2-1 to A2-3 were prepared. Then, test cells (the same structure as the above-described coin-type half cells) were assembled using the cathode active materials A2-1 to A2-3, and their battery capacities (cathode capacities) were measured.

TABLE 5

| Names of | | Primary particle | Cathode |
|---|---|---|---|
| Active | | diameter | capacity |
| materials | Chemical Formula | (nm) | (mAh/g) |
| Cathode active | LiFe_{0.2}Mn_{0.8}PO₄ | 60 | 146 |
| material A2-1 | | | |
| Cathode active | LiFe_{0.2}Mn_{0.8}PO₄ | 100 | 142 |
| material A2-2 | | | |
| Cathode active | LiFe_{0.2}Mn_{0.8}PO₄ | 170 | 57 |
| material A2-3 | | | |

[Capacity Measurement]

With respect to the test cells, cathode capacities were measured in a case where a magnitude of discharge current (discharge rate: C rate) was set to 0.1 C at a discharge temperature of 34° C. The measurement results are also shown in Table 5.

As shown in Table 5, it can be understood that, as the primary particle diameter of the cathode active material becomes smaller (170 nm→100 nm→60 nm), the battery capacity (cathode capacity) becomes larger. By adjusting the particle diameter of primary particles to 100 nm or less, a higher battery capacity (cathode capacity) can be obtained.

[Evaluation on Particle Diameters of Two Cathode Active Materials]

By granulating the cathode active material A1 with a primary particle diameter of 100 nm or less so as to have particle diameters (average particle diameter (D50)) shown in Table 6, cathode active materials A1-1 to A1-4 were prepared. In the same manner, by granulating (classifying) the cathode active material B1 so as to have particle diameters (average particle diameter (D50)) shown in Table 6, cathode active materials B1-1 to B1-2 were prepared. In addition, the cathode active materials A1-1 to A1-4 and the cathode active material B1-1 to B1-2 only have different particle diameters (average particle diameter (D50) of secondary particles), and their compositions are identical to one another. Furthermore, those other than the cathode active material A1-4 are granules.

By using the cathode active materials A1-1 to A1-6 and the cathode active material B1-1 to B1-2 at mass ratios shown in Table 6, test cells (the same structure as the above-described coin-type half cells) were assembled, and their cathode resistances (internal resistances) were measured. The results are also shown in Table 6. The cathode resistances were measured by the above-described measurement method. As to resistance ratios, Test Example 21 in which the cathode active material B was not contained was used as a standard.

TABLE 6

| | Cathode active | | Cathode active | | | |
|---|---|---|---|---|---|---|
| | material A | | material B | | | |
| | Names of | Particle | Names of | Particle | Blending ratios | |
| | the cathode | diameter | the cathode | diameter | of cathode | Resistance |
| | active | (D50) | active | (D50) | active materials | ratios |
| | material A | (μm) | material B | (μm) | A/B | (%) |
| Test Example 21 | A1-1 | 15 | — | — | 100/0 | 100 |
| Test Example 22 | A1-1 | 5 | B1-1 | 10 | 60/40 | 42 |
| Test Example 23 | A1-2 | 15 | B1-1 | 10 | 60/40 | 64 |
| Test Example 24 | A1-3 | 25 | B1-1 | 10 | 60/40 | 100 |
| Test Example 25 | A1-1 | 15 | B1-2 | 15 | 60/40 | 98 |
| Test Example 26 | A1-4 | 1 | B1-1 | 10 | 60/40 | 99 |

As shown in Table 6, in Test Examples 32 to 37 in which mixtures of the cathode active materials A and B were used as cathode active materials, it can be recognized that all the cathode resistances (internal resistances) were almost equal to or lower than that of Test Example 21 in which only the cathode active material A was used.

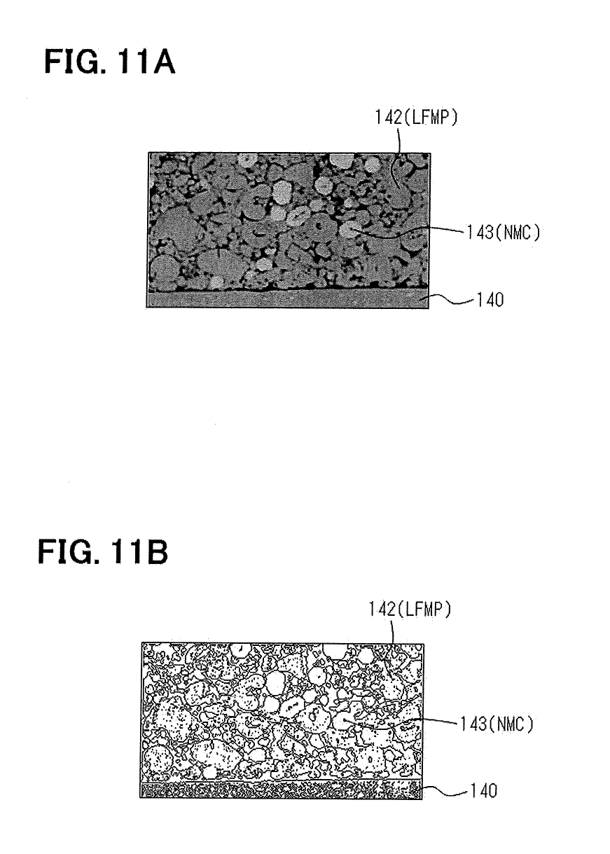

The cross-section of Test Example 32 is shown as an SEM image in FIGS. 11A and 11B. As shown in FIGS. 11A and 11B, it can be recognized that the cathode active material A1-1 and the cathode active material B1-1 are uniformly mixed.

Furthermore, it can be confirmed that, as the particle diameter of the granulated cathode active material A becomes smaller, the cathode resistance becomes smaller. The cathode resistance becomes the smallest in Test Example 13 in which the particle diameter of the granulated cathode active material A was 15 μm or less and in which the particle diameter of the granulated cathode active material B was 10 μM.

In addition, in Test Example 37 in which the cathode active material A was not granulated, coagulation was likely to occur in a slurry in the course of production. In Test Example 24 in which the cathode active material A was granulated into large particles and in Test Example 34 in which the cathode active material B was granulated into large particles, uniform mixture was difficult in slurries in the course of production.

[Evaluation of Second Cathode Active Materials]

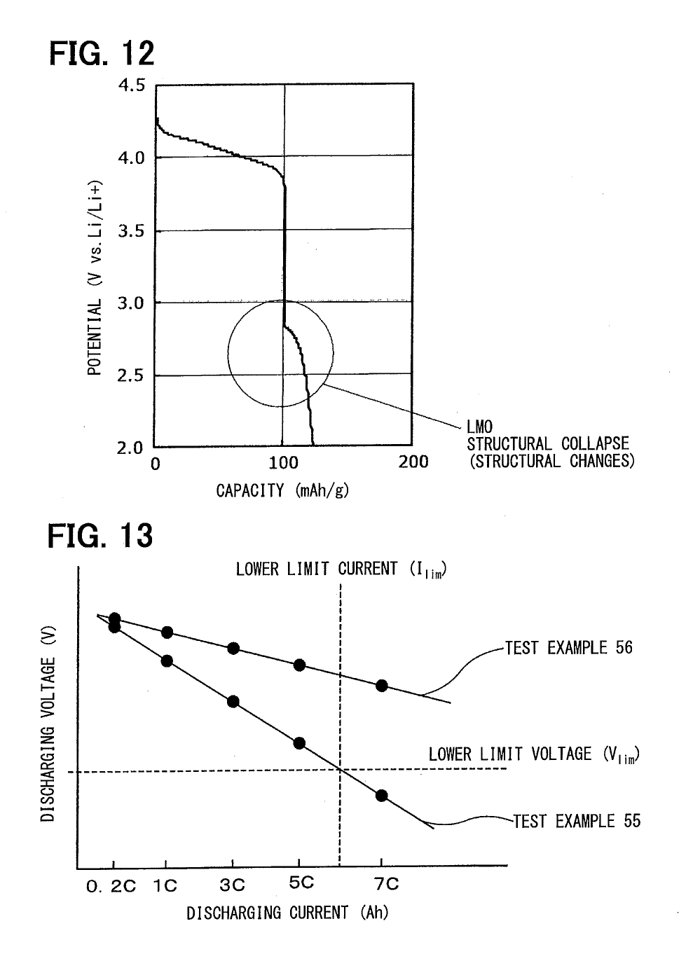

A test cell (the same structure as the above-described coin-type half cells) in which the cathode active material B1 was replaced with the cathode active material B4 (LiMn₂O₄: a spinel structure) shown in Table 7 was assembled, and discharge curves of the cathode were obtained. The discharge curves of the cathode are shown in FIG. 12.

TABLE 7

| | Cathode active | | | | | | | | Numbers of |
|---|---|---|---|---|---|---|---|---|---|
| | material A | | Cathode active material B | | | | Blending ratios | | Intersection |
| | Active | | Names of | | | | of cathode active | Resistance | points of |
| | material | Capacity | active | | | Capacity | materials | Ratios | discharge |
| | species | (mAh/g) | materials | Chemical formula | Structure | (mAh/g) | A/B | (%) | curves |
| Test Example 31 | A2 | 142 | B4 | LiMn₂O₄ | Spinel structure | 110 | 60/40 | 42 | 3 |
| Test Example 3 | A2 | 142 | B1 | LiNi_{1/3}Mn_{1/3}Co_{1/3}O₂ | Layer structure | 155 | 60/40 | 100 | 2 |
| | | | | | α-NaFeO₂ | | | | |
| Test Example 4 | A2 | 142 | — | | | | 100/0 | 64 | 0 |

As shown in Table 7, the cathode active materials A2 and B4 have three intersection points of the discharge curves. Yet the cathode active material B4 has a spinel structure, and the cathode active material A2 has a polyanion structure that contains Fe, and therefore, it is required to set the lower limit voltage to 3V or less. However, when the lower limit voltage was set to 3V or less, there was a problem that the structural collapse (change of structure) occurs in the cathode active material B4 as showed in FIG. 12.

Based on the above, when the cathode active material B is made as an active material of a layer structure (layered rock salt-type structure), the cathode active material B can be mixed with the cathode active material A.

[Evaluation on Mixing Ratios of the Two Cathode Active Materials]

By using the cathode active material A2 and the cathode active material B1 at mass ratios shown in Table 8, test cells (actual cells) were assembled, and a safety test based on overcharge was carried out.

(Test Cells (Actual Cells))

For a cathode, a cathode mixture, which had been obtained by mixing 85 parts by mass of each cathode active material, 10 parts by mass of acetylene black and 5 parts by mass of PVDF, was coated on a cathode collector made of an aluminum foil to form a cathode mixture layer thereon, and the resulting product was used. For the cathode active material, those obtained by mixing the cathode active material A2 and the cathode active material B1 at mass ratios shown in Table 7 were used.

For anodes (counter electrodes), anode mixtures, which had been obtained by mixing 98 parts by mass of an anode active material, 1 part by mass of CMC (solid content: 6 wt %) and 1 part by mass of SBR, were coated on to anode collectors made of a copper foil to form anode mixture layers thereon, and the resulting products were used. For the anode active material, amorphous carbon-coated graphite was used.

For a non-aqueous electrolyte, a product prepared by dissolving LiPF₆ in a mixed solvent of 30% by volume of ethylene carbonate (EC), 30% by volume of dimethyl carbonate (DMC) and 30% by volume of ethyl methyl carbonate (EMC) to 1 mol/L was used. Vinylene carbonate (VC) was added thereto as an additive at 2 mass %, provided that the mass of the non-aqueous electrolyte was regarded as 100 mass % in a condition where any additives were not added thereto.

The cathodes and the anodes, as well as the non-aqueous electrolyte, were sealed in the laminate resin case to assemble test cells (Test Examples 1 to 10).

After being assembled, the test cells were subjected to charging/discharging at 0.2 C, and then, were subjected to a degassing treatment. After that, an aging treatment at 40° C. for two days was carried out.

After the aging treatment, the test cells were subjected to charging/discharging at ⅓ C. Then, their battery capacities at a lower-limit voltage of up to 2.8 V were measured. Consequently, it was revealed that the battery capacities (cell capacities) of all the test cells were 5 Ah.

(Overcharge Test)

First, the test cells were fully charged to a SOC of 100%. Then, CC-CV charging was carried out in a charging condition of 4 C/12 V, and temperatures (surface temperatures) of the test cells during charging were measured. The maximum ultimate temperatures of the measured temperatures are shown together in Table 8.

TABLE 8

| | | | | | Blending | Maximum |
|---|---|---|---|---|---|---|
| | Cathode active | | Cathode active | | ratios of | ultimate |
| | material A | | material B | | cathode | temperatures |
| | Active | | Active | | active | in the |
| | material | Capacities | material | Capacities | materials | overcharge test |
| | species | (mAh/g) | species | (mAh/g) | A/B | (° C.) |
| Test Example 41 | A2 | 142 | B1 | 155 | 70/30 | 103 |
| Test Example 42 | A2 | 142 | B1 | 155 | 60/40 | 110 |
| Test Example 43 | A2 | 142 | B1 | 155 | 30/70 | 240 (Ignited) |
| Test Example 44 | A2 | 142 | — | | 100/0 | 105 |

As shown in Table 8, in Test Example 43 in which the cathode active material B1 was excessively contained, the maximum ultimate temperature was high and ignition occurred. However, in remaining Test Examples 41 to 42 in which the cathode active material B1 (rich in the cathode active material A2) was not excessively contained, it was confirmed that these test examples had almost the same degree of high safety as Test Example 44 in which the cathode active material B1 was not contained.

In other words, when the whole cathode active material is regarded as 100 mass %, a lithium-ion secondary battery with superior safety can be provided by inclusion of 40% or less of the cathode active material B1.

[Evaluation 2]

Next, the above cathode active materials A2-2 and the above cathode active materials B1 and B4-B5 were used to assemble test cells (laminate-type cells, full cells), and the test cells were evaluated.

(Laminate-Type Cells)

The test cells (laminate-type cells) had the same structure as the laminate-type lithium-ion secondary battery 2 whose structure is shown in FIGS. 8 to 9.

For the cathode 34, a cathode mixture, which had been obtained by mixing 85 parts by mass of each cathode active material, 10 parts by mass of acetylene black and 5 parts by mass of PVDF, was coated on a cathode collector 340 made of an aluminum foil to form a cathode mixture layer 341 thereon, and the resulting product was used.

For cathode active materials, those obtained by mixing the above-described cathode active material A2-2 as well as the above-described cathode active materials B1 and B4 to B5 at mass ratios shown in Table 9 were used. In addition, the cathode active material B5 is LiNi_{0.5}Mn_{1.5}O₄ with a spinel structure.

For the anode 37, an anode mixture, which had been obtained by mixing 98 parts by mass of an anode active material, 1 part by mass of CMC and 1 part by mass of PVDF, was coated on to an anode collector 370 made of a copper foil to form an anode mixture layer 371 thereon, and the resulting product was used.

For the anode active material, graphite was used in Test Examples 51 to 54, while Li₄Ti₅O₁₂ (LTO) was used in Test Examples 55 to 58.

As to the graphite in Test Examples 51 to 54, the BET specific surface area was 4 m²/g, and the particle diameter (D50) was 16 μm.

As to the LTO in Test Examples 55 to 58, the BET specific surface area was 16 m²/g, and the primary particle diameter (average particle diameter) was 0.4 μm.

For the non-aqueous electrolyte 13, vinylene carbonate was added to a product, which had been prepared by dissolving LiPF₆ in a mixed solvent of 30% by volume of ethylene carbonate (EC), 30% by volume of dimethyl carbonate (DMC) and 40% by volume of ethyl methyl carbonate (EMC) at 1 mol/L, and the resulting product was used. VC was added thereto at 2 mass %, provided that the mass of the product prepared by dissolving LiPF₆ at 1 mol/L was regarded as 100 mass %.

The assembled test cells were subjected to an activating treatment with charge/discharge at 0.2 C. Then, gases inside the battery cases 3 were removed, and an aging treatment at 40° C. for two days was carried out.

Based on the above, the test cells of the respective test examples (laminate-type cells) were produced.

Charging/discharging at ⅓ C (0.33 C) was carried out with respect to the test cell of each test example (laminate-type cell), and the battery capacity was measured. Consequently, it was confirmed that the battery capacities of all the test cells were 5 Ah.

TABLE 9

| | Cathode active material A | | | | | | | | | |
|---|---|---|---|---|---|---|---|---|---|---|
| | | | | | | Blending | | Anode active | | |
| | Cathode active | | Cathode active | | | ratios of | Numbers of | material | | |
| | materials | | materials B | | | cathode | intersection | Materials | 30% | |
| | Active | | Names of | | | active | points of | for anode | SOC | |
| | material | Capacities | active | | Capacities | materials | discharge | active | output | |
| | species | (mAh/g) | materials | Structure | (mAh/g) | A/B | curves | materials | (V × I) | Remarks |
| Test | A2-2 | 142 | | | | 100/0 | 0 | Graphite | 100 | The cathode active |
| Example | | | | | | | | | | material corresponds |
| 51 | | | | | | | | | | to Test Example 4. |
| Test | A2-2 | 142 | B1 | Layer | 155 | 60/40 | 2 | Graphite | 130 | The cathode active |
| Example | | | | structure | | | | | | material corresponds |
| 52 | | | | α-NaFeO₂ | | | | | | to Test Example 2. |
| Test | A2-2 | 142 | B4 | Spinel | 110 | 60/40 | 3 | Graphite | 102 | The cathode active |
| Example | | | | structure | | | | | | material corresponds |
| 53 | | | | | | | | | | to Test Example 31. |
| Test | A2-2 | 142 | B5 | Spinel | 120 | 60/40 | 1 | Graphite | 88 | |
| Example | | | | structure | | | | | | |
| 54 | | | | | | | | | | |
| Test | A2-2 | 142 | | | | 100/0 | 0 | LTO | 74 | The cathode active |
| Example | | | | | | | | | | material corresponds |
| 55 | | | | | | | | | | to Test Example 4. |
| Test | A2-2 | 142 | B1 | Layer | 155 | 60/40 | 2 | LTO | 122 | The cathode active |
| Example | | | | structure | | | | | | material corresponds |
| 56 | | | | α-NaFeO₂ | | | | | | to Test Example 2. |
| Test | A2-2 | 142 | B4 | Spinel | 110 | 60/40 | 3 | LTO | 95 | The cathode active |
| Example | | | | structure | | | | | | material corresponds |
| 57 | | | | | | | | | | to Test Example 31. |
| Test | A2-2 | 142 | B5 | Spinel | 120 | 60/40 | 1 | LTO | 93 | |
| Example | | | | structure | | | | | | |
| 58 | | | | | | | | | | |

[Output Measurement]

An output test was carried out with respect to the test cells of respective test examples. The output test was carried out by the same technique as the above-described [resistance test]. In addition, lower limit voltages for the test cells (laminate-type cells) of respective test examples were set to voltages lower than operation voltages by 0.6 V.

First, the SOC of each test cell was adjusted to the above-described predetermined value (a SOC of 20% in this test).

Discharging was carried out at respective discharging rates (discharging currents) of 0.2 C/1 C/3 C/5 C/7 C, and the voltages at 10 sec. were measured.

Relations between discharging currents and voltages with respect to Test Examples 55 and 56 are shown in FIG. 13.

Furthermore, outputs after discharging was carried out at 7 C in Test Examples 51 to 58 were obtained. The outputs correspond to outputs at a SOC of 30%, and were calculated from products of discharging rates (discharging currents) and voltage values (I×V). The outputs of respective test examples are shown together in Table 9.

As shown in FIG. 13, it can be confirmed that the test cell of Test Example 56, in which discharge curves of cathode active materials A and B intersect with each other at two or more points, exhibited a higher voltage value, compared to the test cell of Test Example 55 in which only the cathode active material A was contained (the cathode active material B was not contained) and in which discharge curves do not intersect with each other. In other words, it is understood that a higher output can be obtained.

Furthermore, in the test cell of Test Example 56, a rate of changes of voltage due to an increase in the discharging currents (a decreasing rate of voltage shown by the slope of the graph in FIG. 13) is smaller than that of Test Example 55.

On the other hand, in the test cell of Test Example 55, a variation of voltage depending on the currents (a decreasing rate of the output shown by the slope of the graph in FIG. 13) is large, and the decreasing rate of the voltage value becomes larger as discharging is carried out at a lager current. Meanwhile, as for the test cell of Test Example 55, the measured voltage was below the lower limit voltage in discharging at 7 C.

As shown in FIG. 13, in the test cell of Test Example 56, effects in which the cathode resistance (internal resistance) can be more efficiently reduced in a high discharging region (a region where the SOC is low), as compared with the test cell of Test Example 55.

Moreover, as shown in Table 9, it can be confirmed that the output value is higher in the test cells whose respective discharge curves of the cathode active materials A and B intersect with each other at two or more points, compared with the test cells that contained only the cathode active material A (did not contain the cathode active material B) and whose discharge curves do not intersect with each other, in either of cases where the anode active material is graphite (Test Examples 51 to 54) or LTO (Test Examples 55 to 58). In other words, it can be understood that a larger output was obtained.

In addition, as for the test cell of Test Example 55 in Table 9, the battery voltage after discharging was below the set lower limit voltage, and therefore, the output corresponds to the product (Iₗᵢₘ×Vₗᵢₘ) of the lower limit current (Iₗᵢₘ), which is a discharging current when the battery voltage reached a value of the lower limit voltage, and the value of the lower limit voltage (Vₗᵢₘ).

The anode active material (graphite) of Test Example 52 is an active material whose Li/Li⁺ potential is considerably low, and a difference between its potential and the potential of the cathode active material is considerably large. In other words, the battery voltage becomes larger (the operation voltage becomes broader), and the lower limit voltage can be set to a lower value. That is, in the test cell of Test Example 52, the battery voltage after discharging is unlikely to be below the set lower limit voltage, and the output value becomes higher.

As to anode active material (LTO) of Test Example 56, its Li-ion diffusion coefficient is higher than that of graphite. In other words, Li ions quickly diffuse thereto, and therefore, an influence of the internal resistance can be suppressed.

In addition, as shown in Table 9, Test Example 52 exhibited a superior output in a high discharging region (a region where the SOC is low), compared to Test Examples 53 to 54, and Test Example 56 also exhibited a superior output in the high discharging region, compared with Test Examples 57 to 58. In other words, Test Examples 52 and 56, in which the cathode active material B had a layered structure, exhibited a superior output in a high discharging region (a region where the SOC is low), compared to Test Examples 53 to 54 and 57 to 58 in which the cathode active material B had a spinel structure. This is because, as described above for FIG. 12, while structural collapse (structural change) occurs in the cathode active material B of a spinel structure (Test Examples 53 to 54 and 57 to 58), any structural collapse (structural changes) does not occur in the layered structure of the cathode active material B (Test Example 52 and 56).

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A lithium-ion secondary battery comprising:
a first cathode active material having a polyanion structure which stores and releases a lithium ion; and
a second cathode active material having a lithium diffusion coefficient different from a lithium diffusion coefficient of the first cathode active material,
wherein the second cathode active material has a layered rock salt-type structure, and
wherein a discharge curve of the first cathode material and a discharge curve of the second cathode material intersect with each other at at least two points.

2. The lithium-ion secondary battery according to claim 1,
wherein the first cathode active material is made of Li_{α}Fe_{β}M_{1-β}XO_{4-γ}Z_{γ}
wherein 0<β≦0.4, and
wherein M is one or more elements selected from Mn, Cr, Co, Cu, Ni, V, Mo, Ti, Zn, Al, Ga, B and Nb.

3. The lithium-ion secondary battery according to claim 1,
wherein the first cathode active material is a granular body made of granulating primary particles having a particle diameter equal to or less than 100 nanometers, and
wherein an average particle diameter of the granular body is equal to or less than 15 micrometers.

4. The lithium-ion secondary battery according to claim 1,
wherein the second cathode active material is made of Li_{y}M′_{z}O₂
wherein 0.05<y<1.2,
wherein 0.7<z≦0.1,
wherein M′ is one or more elements selected from Ni, Mn, Fe, Cr, Co, Cu, V, Mo, Ti, Zn, Al, Ga, B and Nb, and
wherein the second cathode active material has an average particle diameter equal to or less than 10 micrometers.

5. The lithium-ion secondary battery according to claim 1,
wherein a mass ratio of a total cathode active material is defined as 100%, and
wherein a mass ratio of the second cathode active material is equal to or less than 40%.

6. The lithium-ion secondary battery according to claim 1,
wherein a battery capacity of the first cathode active material is equal to or lower than a battery capacity of the second cathode active material.

7. The lithium-ion secondary battery according to claim 1,
wherein the lithium-ion diffusion coefficient of the first cathode active material is defined as KA,
wherein the lithium-ion diffusion coefficient of the second cathode active material is defined as KB, and
wherein the lithium-ion diffusion coefficient of the first cathode active material and the lithium-ion diffusion coefficient of the second cathode active material have a relationship of log(KA/KB)≧6.

8. The lithium-ion secondary battery according to claim 1 further comprising:
an anode active material having a potential of Li or Li⁺ in a range between 0.5 and 2 V.

9. The lithium-ion secondary battery according to claim 8,
wherein the anode active material is spinel-type lithium titanate.

10. The lithium-ion secondary battery according to claim 8,
wherein a lower-limit voltage of the lithium-ion secondary battery is a voltage smaller by a certain voltage than an operation voltage, and
wherein the certain voltage is in a range between 0.5V and 1.5V.
